(19) United States
(12) Patent Application Publication
(10) Pub. No.: US 2005/0160161 A1
(43) Pub. Date: Jul. 21, 2005

(54) System and method for managing a proxy request over a secure network using inherited security attributes

(75) Inventors: Jeremey Barrett, Sugar Land, TX (US); Craig R. Watkins, State College, PA (US); Adam Cain, Madison, WI (US)

Correspondence Address: DARBY & DARBY P.C., P.O. BOX 5257, NEW YORK, NY, 10150-6257, US

(73) Assignee: Nokia, Inc., Irving, TX (US)

(21) Appl. No.: 10/748,845

(22) Filed: Dec. 29, 2003

(51) Int. Cl. G06F 15/173

(52) U.S. Cl. 709/223

(57) ABSTRACT

Methods, devices, and systems are directed to managing a proxy request over a secure network using inherited security attributes. Proxy traffic, such as HTTP proxy traffic, is tunneled through a secure tunnel such that the proxy request inherits security attributes of the secure tunnel. The secure attributes may be employed to enable proxy access to a server, thereby extending a security property of the secure tunnel to the proxy connection tunneled through it. A secure tunnel service receives a proxy request from a client and modifies the proxy request to include the security attribute. In one embodiment, the security attribute is an identifier that enables a proxy service may employ to determine another security attribute. The proxy service is enabled to employ the security attribute, and the security attribute to determine if the client is authorized access to the server.

### FIELD OF THE INVENTION

The present invention relates to computer security, and in particular, to a system and method for managing a proxy request over a secure network using inherited authentication and authorization attributes.

### BACKGROUND

A proxy service typically resides within a server that may sit between a client application, such as a web browser, and another server, such as a content server. The proxy service may be configured to manage a communication with the client application on behalf of the other server. The proxy service may operate as a server to the client application and as a client to the other server. Proxy services are often employed to assist the client application in accessing a server in an intranet.

Proxy services, sometimes called application proxies, generally come in two flavors: generic and application-aware. With generic-proxies, such as SOCKetS (SOCKS) proxies, and the like, a client application on the Internet that wishes to communicate with a server on an Intranet, often must open a connection to the proxy service, and proceed through a proxy specific protocol to indicate the actual server's location. The generic-proxy opens the connection on behalf of the client application, at which point a normal application protocol may commence. The generic-proxy generally operates thereafter essentially as a simple relay mechanism.

Application-aware proxy services include proxy servers that are enabled to be cognizant of an application protocol they support. Application-aware proxy services include FTP, Telnet, HTTP, and the like.

Typically, application-aware proxy services operate to control access to the desired application on a server by authenticating the client application, ensuring that the client application is authorized to access the server, and permitting access to the server. In many of the application-aware proxy services, such as the HTTP proxy service, access control decisions are based on properties of the underlying TCP connection on which the proxy service receives a request for access.

In many situations, however, security is also desired to protect the communication between the client application and the server. Protection of the communication is often enabled using a secure tunnel. The secure tunnel may be implemented employing a variety of mechanisms, including HTTPS/SSL, TLS, and the like. This secure tunnel may be created by forwarding traffic between the client and proxy application using a separate application acting as an intermediary.

Unfortunately, use of the secure tunnel may hinder access to properties of the underlying TCP connection employed by the proxy service. This may make it difficult to securely protect the communication to the server and the client's proxy access to the server. Additionally, the proxy service may have little, if any, knowledge of the security properties of the secure tunnel, for example, due to the inability to express the security properties in an application protocol employed by the client and proxy service. This further complicates a protection scheme for both the communication and the proxy access to the server. Therefore, there is a need in the industry for improved methods and systems for managing a proxy request over a secure network. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention operates;

FIG. 2 illustrates a block diagram of one embodiment of functional components operable within secure proxy system 100 for use in managing a proxy request over a secure network;

FIG. 3 illustrates a block diagram of one embodiment of an access server that may be employed to perform the invention;

FIG. 4 illustrates a block diagram of one embodiment of a client device that may be employed to perform the invention; and

FIG. 5 is a flow chart illustrating a process for managing a proxy request over a secure network using inherited security attributes, according to one embodiment of the invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

The term “packet” includes an IP (Internet Protocol) packet. The term “flow” includes a flow of packets through a network. The term “connection” refers to a flow or flows of packets that typically share a common source and destination.

Briefly stated, the present invention is directed to a system, device, and method for managing a proxy request over a secure network using inherited security attributes. Proxy traffic, such as HTTP proxy traffic, is tunneled through a security tunnel such that the proxy request inherits security attributes of the secure tunnel. The secure attributes may be employed to enable proxy access to a server, thereby extending a security property of the secure tunnel to the proxy connection tunneled through it. A secure tunnel service receives a proxy request from a client and modifies the proxy request to include at least one security attribute. The at least one security attribute may then be employed by proxy service to grant access to the server. In one embodiment, the secure tunnel is an HTTPS established tunnel. A security attribute may include an IP address associated with the client, a security property associated with the secure tunnel, a public key certificate, access control data configured to enable the client access to a content server, a security credential associated with the client, a session identifier, and the like. In one embodiment the security attribute is an identifier that the proxy service may employ to determine an additional security attribute. If the client is authorized based on the inherited security attribute, a connection to the requested server may be established.

Illustrative Operating Environment

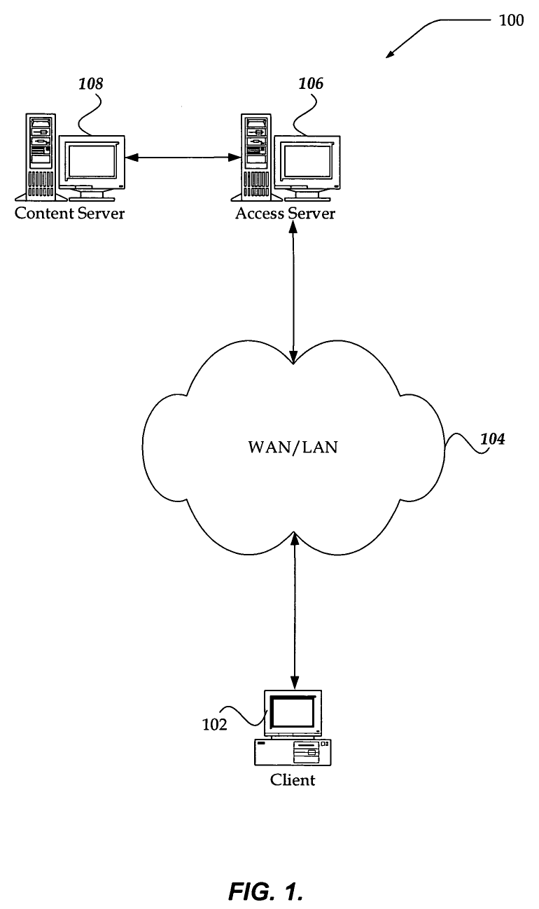

FIG. 1 illustrates one embodiment of an environment in which a system operates. However, not all of these components may be required to practice the invention, and variations in the arrangement and type of the components may be made without departing from the spirit or scope of the invention.

As shown in the figure, secure proxy system 100 includes client 102, Wide Area Network (WAN)/Local Area Network (LAN) 104, access server 106, and content server 108. WAN/LAN 104 is in communication with client 102 and access server 106. Access server 106 is in communication with content server 108.

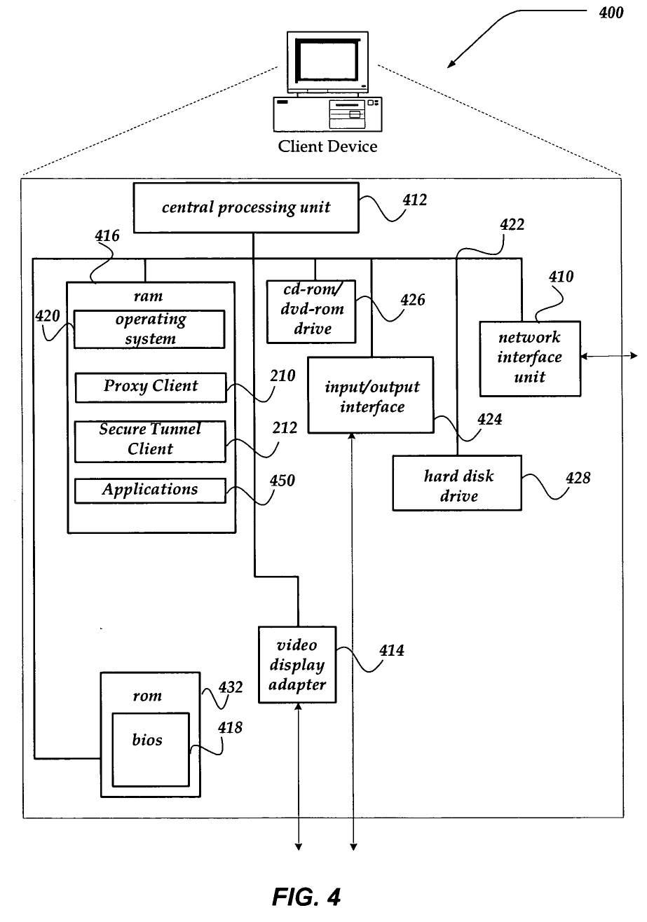

Client 106 may be any network device capable of sending and receiving a packet over a network, such as WAN/LAN 104, to and from another network device, such as access server 106. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, client 102 may be any device that is capable of connecting using a wired or wireless communication medium such as a PDA, POCKET PC, wearable computer, and any other device that is equipped to communicate over a wired and/or wireless communication medium. One embodiment of client 102 is described in more detail below, in conjunction with FIG. 4.

WAN/LAN 104 is enabled to employ any form of computer readable media for communicating information from one electronic device to another. In addition, WAN/LAN 104 can include the Internet in addition to local area networks (LANs), wide area networks (WANs), direct connections, such as through a universal serial bus (USB) port, other forms of computer-readable media, and any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links. Furthermore, remote computers and other related electronic devices could be remotely connected to either LANs or WANs via a modem and temporary telephone link.

As such, it will be appreciated that the Internet itself may be formed from a vast number of such interconnected networks, computers, and routers. Generally, the term “Internet” refers to the worldwide collection of networks, gateways, routers, and computers that use the Transmission Control Protocol/Internet Protocol (“TCP/IP”) suite of protocols to communicate with one another. At the heart of the Internet is a backbone of high-speed data communication lines between major nodes or host computers, including thousands of commercial, government, educational, and other computer systems, that route data and messages. An embodiment of the invention may be practiced over the Internet without departing from the spirit or scope of the invention.

The media used to transmit information in communication links as described above illustrates one type of computer-readable media, namely communication media. Generally, computer-readable media includes any media that can be accessed by a computing device. Computer-readable media may include computer storage media, communication media, or any combination thereof. Communication media typically embodies computer-readable instructions, data structures, program modules, or other data in a modulated data signal such as a carrier wave or other transport mechanism and includes any information delivery media. The term “modulated data signal” includes a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

Access server 106 may include any computing device capable of managing a flow of packets between client 102 and content server 108. Each packet in the flow of packets may convey a piece of information. A packet may be sent for handshaking, i.e., to establish a connection or to acknowledge receipt of data. The packet may include information such as a request, a response, and the like. For example, a packet may include a request to access server 108. The packet may also include a request to establish a secure communication between access server 108 and client 102. As such, the packets communicated between client 102 and access server 108 may encrypted employing any of a variety of security techniques, including, but not limited to those employed in a Secure Sockets Layer (SSL), Layer 2 Tunneling Protocol (L2TP), Transport Layer Security (TLS), Tunneling TLS (TTLS), IPSec, HTTP Secure (HTTPS), Extensible Authentication Protocol, (EAP), and the like.

Generally, packets received between client 102 and access server 106 will be formatted according to TCP/IP, but they could also be formatted using another transport protocol, such as User Datagram Protocol (UDP), Internet Control Message Protocol (ICMP), NETbeui, IPX/SPX, token ring, and the like. In one embodiment, the packets are HTTP formatted packets.

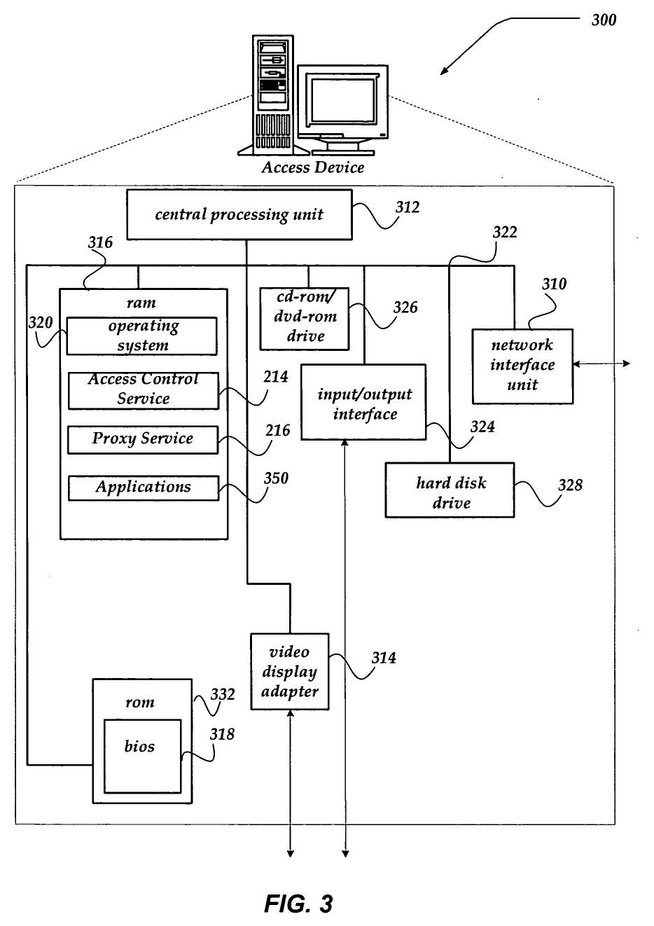

In one embodiment, access server 106 is configured to shield content server 108 from an unauthorized access. As such, access server 106 may include a variety of packet filters, proxy applications, and screening applications to determine if a packet is authorized. As such, access server 106 may be configured to operate as a gateway, firewall, reverse proxy server, proxy server, secure bridge, and the like. In one embodiment, access server 106 is operable as an HTTP/SSL-VPN gateway. One embodiment of access server 106 is described in more detail below, in conjunction with FIG. 3.

Although access server 106 is illustrated as a single device in FIG. 1, the present invention is not so limited. Components of access server 106 that manage access and communications between client 102 and content server 108 may be arranged across multiple network devices, without departing from the scope of the present invention. For example, in one embodiment, a component that manages a secure tunnel for communications between client 102 and content server 108 may be deployed in one network device, while a proxy service for managing access control to content server 108 may be deployed in another network device.

Content server 108 may include any computing device configured to provide content to a client, such as client 102. Content server 108 may be configured to operate as a website, a File System, a File Transfer Protocol (FTP) server, a Network News Transfer Protocol (NNTP) server, a database server, an application server, and the like. Devices that may operate as content server 108 include, but are not limited to, personal computers desktop computers, multiprocessor systems, microprocessor-based or programmable consumer electronics, network PCs, servers, and the like.

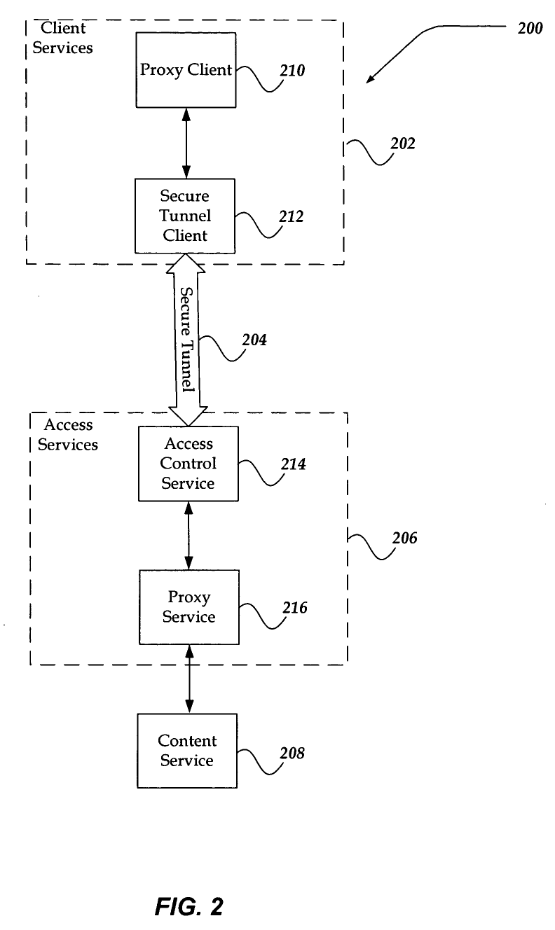

FIG. 2 illustrates a block diagram of one embodiment of functional components operable within secure proxy system 100 for use in managing a proxy request over a secure network. Not all the components may be required to practice the invention, and variations in the arrangement and type of the components may be made without departing from the spirit or scope of the invention.

As shown in the figure, functional components 200 include client services 202, secure tunnel 204, access services 206, and content service 208. Client services 202 include proxy client 210 and secure tunnel client 212. Access services 206 include access control service 214 and proxy service 216.

Secure tunnel client 212 is in communication with proxy client 210 and secure tunnel 204. Access control service 214 is in communication with secure tunnel 204 and proxy service 216. Proxy service 216 is further in communication with content service 208.

Client services 202 may, for example, reside within client 102 of FIG. 1, while access services 206 may reside within access server 106 of FIG. 1.

Proxy client 210 may include virtually any service or set of services configured to enable a request for a proxy connection, and to maintain the proxy connection with another application. In one embodiment, the other application resides on another device, such as access server 106 of FIG. 1. Proxy client 210 may employ any of a variety of mechanisms to request and maintain the proxy connection, including, but not limited to, a web browser, an HTTP proxy client, a port-forwarding application, a port-forwarding applet, a java enabled proxy client, and the like.

Secure tunnel client 212 includes virtually any service that is configured to enable a client, such as client 102 of FIG. 1, to establish a secure tunnel with access control service 214. Secure tunnel client 212 may include components within a web browser, for example, that enables establishment of the secure tunnel. Secure tunnel client 212 may further include components such as SSL components, TLS components, encryption/decryption components, Extensible Authentication Protocol (EAP) components, IPSec components, HyperText Transfer Protocol Secure (HTTPS) components, 802.11 security components, SSH components, and the like.

Secure tunnel client 212 may further include a store, database, text file, and the like, configured to store security attributes employed to generate and maintain the secure tunnel. Such security attributes may include, but are not limited to, certificates, including X.509 certificates and similar public/private key certificates, encryption keys, and the like. Security attributes may also be added, shared, and the like, between parties to the secure transaction.

Secure tunnel 204 includes virtually any mechanism that enables a secure communication over a network between a client and a server, such as client 102 and access server 106 of FIG. 1. Secure tunnel 204 may enable a transmission of a packet in one protocol format within another protocol format. Secure tunnel 204 may employ encapsulation, encryption, and the like, to ensure that the communication is secure. Secure tunnel 204 may employ a variety of mechanisms to secure the communication, including, but not limited to SSL, TLS, EAP, IPSec, HTTPS, Wireless Equivalent Privacy (WEP), Wi-Fi Protected Privacy (WPA), Wireless Link Layer Security (wLLS), and the like.

Access control service 214 includes virtually any service or set of services that enable a server, such as access server 106 of FIG. 1, to establish and maintain secure tunnel 204 with a client. Access control service 214 may include substantially similar components to secure tunnel client 212, configured to operate in a server role. As such, access control service 214 may include SSL components, TLS components, encryption/decryption components, EAP components, IPSec components, HTTPS components, 802.11 security components, SSH components, and the like.

Access control service 214 may further include a store, database, text file, and the like, configured to store a security attribute employable to generate and maintain the secure tunnel, including access control permissions (e.g., authorizations). Such security attributes may include, but are not limited to, certificates, including X.509 certificates and similar public/private key certificates, randomly generated data, encryption keys, and the like, associated with access services 206.

Access control service 214 is further configured to receive a proxy request over the secure tunnel. Access control service 214 may modify the proxy request by including with the proxy request a security attribute. Access control service 214 may combine a header with the proxy request, where the header includes the security attribute. Access control service 214 may select to encrypt the header, the header and the proxy request, and the like.

By modifying the proxy request to include the security attribute, the present invention may enable a full range of access control options without being required to modify content being delivered to a client. As there is a diversity of content available to proxy clients, the diversity renders modifying the content as an inherently incomplete and potentially dissatisfying solution.

The security attribute may be associated with a property of secure tunnel 204. The security attribute may also be associated with a security property of a client, such as client 102 of FIG. 1. Such security properties may include access control data, IP address, digital certificate, and the like. The security attribute may further include an identifier associated with the client that enables proxy service 216 to determine additional security attributes associated with the client.

Access control service 214 is configured to establish a connection with proxy service 216 and forward the modified proxy request towards proxy service 216. In one embodiment, the connection between access control service 214 and proxy service 216 includes a secure connection. This secure connection may be established using any of a variety of mechanisms, including, but not limited to, creating another secure tunnel, encapsulating a communication between access control service 214 and proxy service 216, encrypting the communication, and the like.

Access control service 214 may be further configured to differentiate a proxy request for a known proxy service, such as proxy service 216, from other requests, other communications such as control information between secure tunnel client 212 and access control service 214, and the like.

Proxy service 216 includes virtually any service enabled to manage a communication with a client application on behalf of the content service 208. Proxy service 216 is further configured to receive the modified proxy request from access control service 214.

Proxy service 216 may employ the security attribute to retrieve an additional security attribute associated with a requesting client application, secure tunnel, access control permissions, and the like. The additional security attribute may reside in a store, database, text file, and the like. The security attribute store (not shown) may be maintained by proxy service 216, access control service 214, jointly by both proxy service 216 and access control service 214, and even by another service (not shown).

Proxy service 216 may employ the security attribute within the header to determine whether to authorize the proxy request, fulfill the proxy request, respond with an error message, or the like.

Proxy service 216 may be further configured to differentiate between a connection that has arrived ‘forwarded’ over a secure tunnel from another connection that has arrived over a non-secure tunnel, network, and the like.

FIG. 3 illustrates a block diagram of one embodiment of an access server that may be employed to perform the invention. Access device 300 may include many more components than those shown. The components shown, however, are sufficient to disclose an illustrative embodiment for practicing the invention.

Access device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of access device 300. Any general-purpose operating system may be employed. Basic input/output system (“BIOS”) 318 is also provided for controlling the low-level operation of access device 300.

As illustrated in FIG. 3, access device 300 also can communicate with the Internet, or some other communications network, such as WAN/LAN 104 in FIG. 1, via network interface unit 310, which is constructed for use with various communication protocols including the TCP/IP protocol. Network interface unit 310 is sometimes known as a transceiver or transceiving device.

The mass memory as described above illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information.

In one embodiment, the mass memory stores program code and data for implementing operating system 320. The mass memory may also store additional program code and data for performing the functions of access device 300. One or more applications 350, and the like, may be loaded into mass memory and run on operating system 320. Access control 214 and proxy service 216, as described in conjunction with FIG. 2, are examples of other applications that may run on operating system 320.

Access device 300 may also include input/output interface 324 for communicating with external devices, such as a mouse, keyboard, scanner, or other input devices not shown in FIG. 3. Likewise, access device 300 may further include additional mass storage facilities such as CD-ROM/DVD-ROM drive 326 and hard disk drive 328. Hard disk drive 328 is utilized by access device 300 to store, among other things, application programs, databases, and the like.

FIG. 4 illustrates a block diagram of one embodiment of a client device that may be employed to perform the invention. Client device 400 may include many more components than those shown. The components shown, however, are sufficient to disclose an illustrative embodiment for practicing the invention.

As illustrated in the figure, client device 400 may include many components that are substantially similar to components in access server 300. However, the invention is not so limited, and client device 400 may include more or less components than access server 300.

As illustrated in FIG. 4, however, client device 400 includes processing unit 412, video display adapter 414, and a mass memory, all in communication with each other via bus 422. The mass memory generally includes RAM 416, ROM 432, and one or more permanent mass storage devices, such as hard disk drive 428, tape drive, optical drive, and/or floppy disk drive. The mass memory stores operating system 420 for controlling the operation of client device 400. Virtually any general-purpose operating system may be employed. Basic input/output system (“BIOS”) 418 is also provided for controlling the low-level operation of client device 400.

In one embodiment, the mass memory stores program code and data for implementing operating system 420. The mass memory may also store additional program code and data for performing the functions of client device 400. One or more applications 450, and the like, including proxy client 210 and secure tunnel client 212 as described in conjunction with FIG. 2, may be loaded into mass memory and run on operating system 420.

Client device 400 also can communicate with the Internet, or some other communications network, such as WAN/LAN 104 in FIG. 1, via network interface unit 410. Client device 400 also includes input/output interface 424 for communicating with external devices, such as a mouse, keyboard, scanner, or other input devices not shown in FIG. 4. Likewise, client device 400 may further include additional mass storage facilities such as CD-ROM/DVD-ROM drive 426 and hard disk drive 428. Hard disk drive 428 is utilized by client device 400 to store, among other things, application programs, databases, and the like.

Illustrative Method for Managing a Proxy Over a Secure Network

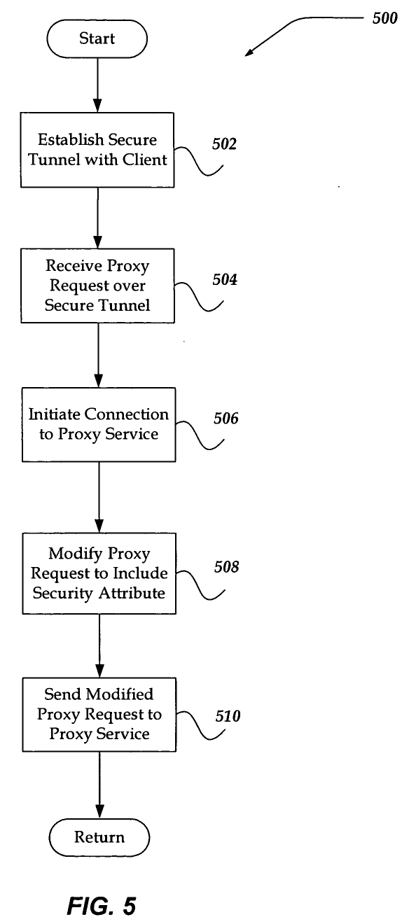

FIG. 5 is a flow chart illustrating a process for managing a proxy request over a secure network using inherited security attributes, according to one embodiment of the invention. In one embodiment, process 500 is implemented within access server 300 of FIG. 3.

Process 500 begins, after a start block, at block 502, where a secure tunnel is established with a client. In one embodiment, the client may authenticate out of band to establish a session directly with an access service, and to establish at least one security attribute. In another embodiment, the secure tunnel is established between the client and an access service. The access service may include, but is not limited to, a gateway application, filter application, SSL server application, and the like. In one embodiment of the invention, the secure tunnel may be established using a secure tunnel client, and the like. The secure tunnel client may employ any of a variety of mechanisms to establish the secure tunnel, including, but not limited, to employing an HTTPS request, an SSL mechanism, TLS mechanism, TTLS mechanism, PEAP mechanism, IPSec mechanism, and the like. Establishing the secure tunnel may result in the client sending a security attribute that includes, but is not limited to, an encryption key, a credential, a certificate, a cipher setting, randomly generated data, IP address, and the like, to the access service. The access service may employ the security attribute to authenticate the client, and establish the secure tunnel. Upon establishment of the secure tunnel processing proceeds to block 504.

At block 504, a proxy request is received over the secure tunnel. In one embodiment, the client sends the proxy request to the access service. The client may employ any of a variety of mechanisms to send the proxy request. For example, the client may initiate an action by a port-forwarding applet, or similar proxy client within the context of a secure tunnel session. In one embodiment, the proxy client is an HTTP proxy client. The client may, for example, select and configure a web browser, or similar application, to employ the port-forwarding applet, and the like, as its proxy client. The client, through the web browser, and the like, may then make the proxy request, using a URL, a NAT assigned address, and the like. The web browser may then employ the proxy client to forward the proxy request over the secure tunnel to the access service.

Processing continues to block 506, where a connection to a proxy service is initiated. The connection may be initiated by the access server by opening a connection to the proxy service. In one embodiment, the proxy service may connect to a secure port, and the like, to establish the connection. In another embodiment, the proxy service may connect using a loop-back address, such as 127.0.0.1, and the like, to establish the connection.

Process 500 proceeds to block 508, where the proxy request received from the proxy client over the secure tunnel is modified to include a security attribute. The security attribute includes, in one embodiment, an identifier that may be employed by the proxy service to look up an additional security attribute. The additional security attribute may be maintained by the access service on behalf of the proxy service. The additional security attribute may also be maintained by the proxy service based on prior known information about the client, secure tunnel, and the like, including, but not limited to, password information, TCP/IP address information, encryption keys, public/private key certificates, client access rights, and the like.

The security attribute employed to modify the proxy request may further include, but is not limited to, a security property associated with the secure tunnel, a public key certificate, a security credential associated with the client, a session identifier, a cipher setting, randomly generated data, an encrypted password, and the like. The security attribute may also include virtually any security attribute associated with the secure tunnel.

The security attribute may be employed to modify a packet header, encapsulation header, and the like. The header may then be combined with the proxy request to generate the modified proxy request.

Processing continues to block 510, where the modified proxy request is forwarded to the proxy service. The proxy service may employ the modified proxy request, including the security attribute within the header, to determine whether to authorize the proxy request, or respond with an appropriate error message, and the like. In any event, upon completion of block 510, process 500 returns to a calling process to perform other actions. In one embodiment, the other actions include, but are not limited to, the proxy service handling the request and responding with desired content, providing an error message, and the like.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Although the invention is described in terms of a packet communicated between a client device and a server, the invention is not so limited. For example, the packet may be communicated between virtually any resource, including but not limited to multiple clients, multiple servers, and any other device, without departing from the scope of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A network device for managing a communication over a network, comprising:
a transceiver arranged to send and to receive the communication over the network;
a processor, coupled to the transceiver, that is configured to perform actions, including:
receiving a proxy request from a client through a secure tunnel;
modifying the proxy request to include a security attribute; and
forwarding the modified proxy request to a proxy service, wherein the security attribute enables a proxy connection through the secure tunnel.

2. The network device of claim 1, wherein modifying the proxy request further comprises including a security header with the proxy request.

3. The network device of claim 1, wherein the security attribute further comprises at least one of an IP address associated with the client, a security property associated with the secure tunnel, a public key certificate, a security credential associated with the client, access control data configured to enable the client access to a content server, a session identifier, and an identifier associated with the secure tunnel.

4. The network device of claim 1, wherein the proxy request is an HTTP proxy request.

5. The network device of claim 1, wherein the secure tunnel further comprises at least one of an SSL tunnel, a TLS tunnel, HTTP Secure (HTTPS), Tunneling TLS (TTLS), and an EAP secure tunnel.

6. The network device of claim 1, further comprising receiving an HTTPS communication to enable the secure tunnel.

7. An apparatus for managing a communication over a network, comprising:
a transceiver arranged to send and to receive the communication over the network;
a processor, coupled to the transceiver, that is configured to perform actions, including:
establishing a secure tunnel between the apparatus and a client;
receiving a proxy request from the client through the secure tunnel;
modifying the proxy request to include a security attribute; and
forwarding the modified proxy request to a proxy service, wherein the security attribute enables a proxy connection through the secure tunnel.

8. The apparatus of claim 7, wherein establishing the secure tunnel further comprises receiving an HTTPS communication.

9. The apparatus of claim 7, wherein the apparatus is operable as at least one of a firewall, a gateway, and a proxy server.

10. A method for managing a communication over a network, comprising:
receiving a proxy request from a client through a secure tunnel;
modifying the proxy request to include a security attribute; and
forwarding the modified proxy request to a proxy service, wherein the security attribute enables a proxy connection through the secure tunnel.

11. The method of claim 10, wherein modifying the proxy request further comprises associating a security header with the proxy request.

12. The method of claim 10, wherein the security attribute further comprises at least one of an IP address associated with the client, a security property associated with the secure tunnel, a public key certificate, access control data configured to enable the client access to a content server, a security credential associated with the client, a session identifier, and an identifier.

13. The method of claim 10, wherein the proxy request is an HTTP proxy request.

14. The method of claim 10, wherein the secure tunnel further comprises at least one of an SSL tunnel, a TLS tunnel, HTTP Secure (HTTPS), Tunneling TLS (TTLS), IPSec tunnel, and an EAP secure tunnel.

15. The method of claim 10, further comprising receiving an HTTPS communication to enable the establishment of the secure tunnel.

16. The method of claim 10, further comprising:
initiating a connection to a secure tunnel client; and
sending the proxy request to the secure tunnel client, wherein the secure tunnel client is configured to forward the proxy request over the secure tunnel.

17. The method of claim 10, wherein modifying the proxy request further comprises modifying the proxy request employing an access control service.

18. A system for managing a communication over a network, comprising:
a client that is configured to perform actions, including:
determining a secure tunnel; and
sending a proxy request through the determined secure tunnel; and
a server, coupled to the client, that is configured to perform actions, including:
receiving the proxy request from the client through the secure tunnel;
modifying the proxy request to include a security attribute; and
forwarding the modified proxy request to a proxy service, wherein the security attribute enables a proxy connection through the secure tunnel.

19. The system of claim 18, wherein the client further comprises:
a proxy client that is configured to generate a proxy request; and
a secure tunnel client, coupled to the proxy client, that is configured to establish the secure tunnel with the server.

20. The system of claim 19, wherein the proxy client further comprises a port-forwarding client application.

21. The system of claim 18, wherein modifying the proxy request further comprises including a security header with the proxy request.

22. The system of claim 18, wherein the security attribute further comprises at least one of an IP address associated with the client, a security property associated with the secure tunnel, a public key certificate, access control data configured to enable the client access to a content server, a security credential associated with the client, a session identifier, and an identifier associated with the secure tunnel.

23. The system of claim 18, wherein the proxy request is an HTTP proxy request.

24. The system of claim 18, wherein the secure tunnel further comprises a means for securing the communication over the network.

25. The system of claim 18, wherein the secure tunnel further comprises at least one of an SSL tunnel, a TLS tunnel, HTTP Secure (HTTPS), Tunneling TLS (TTLS), IPSec tunnel, and an EAP secure tunnel.

26. The system of claim 18, wherein determining the secure tunnel further comprises generating an HTTPS message to enable the secure tunnel.

27. An apparatus for managing a communication over a network, comprising:
a transceiver arranged to send and to receive the communication over the network;
a processor, coupled to the transceiver, that is configured to receive a proxy request from a client through a secure tunnel;
a means for modifying the proxy request to include a security attribute; and
a means for forwarding the modified proxy request to a proxy service, wherein the security attribute enables a proxy connection through the secure tunnel.

28. The apparatus of claim 27, wherein the secure tunnel further comprises a means for securing the communication over the network.
